(19) United States
(12) Patent Application Publication
(10) Pub. No.: US 2023/0226524 A1
(43) Pub. Date: Jul. 20, 2023

(54) PHOTOCATALYTICALLY ACTIVE PARTICULATE MATERIAL BASED ON ZNS, METHOD FOR THE PRODUCTION AND USE THEREOF

(71) Applicant: VENATOR GERMANY GMBH, DUISBURG (DE)

(72) Inventors: THOMAS LANGE, DUISBURG (DE); MARKUS ROHE, MOERS (DE)

(73) Assignee: VENATOR GERMANY GMBH, DUISBURG (DE)

(21) Appl. No.: 17/915,485

(22) PCT Filed: Mar. 26, 2021
(86) PCT No.: PCT/EP2021/057958

§ 371 Date: Sep. 29, 2022

(30) Foreign Application Priority Data
Apr. 1, 2020 (EP) 20167600.4

(51) Int. Cl. B01J 23/52; B01J 27/04; B01J 21/04; B01J 21/08; B01J 21/06; B01J 35/02; B01J 35/00; B01J 37/02; B01J 37/34; B01J 37/08; B01J 37/00; B01J 31/38; B01J 31/06; C02F 1/72; C02F 1/32

(52) U.S. Cl. CPC B01J 23/52; B01J 27/04; B01J 21/04; B01J 21/08; B01J 21/063; B01J 35/023; B01J 35/026; B01J 35/0013; B01J 35/0066; B01J 35/006; B01J 37/0244; B01J 37/0228; B01J 37/0221; B01J 37/344; B01J 37/08; B01J 37/0009; B01J 31/38; B01J 31/06; C02F 1/725; C02F 1/32; C02F 2101/308

(57) ABSTRACT

A photocatalytically active particulate material includes a particle core of ZnS, particles of a nanoscale metal selected from Au, Ag, Pt, Pd, Cu or an alloy thereof loaded on the particle core, and a layer of Al2O3, SiO2, TiO2 or mixtures thereof on the loaded particle core.

### CROSS REFERENCE TO PRIOR APPLICATIONS

This application is a U.S. National Phase application under 35 U.S.C. § 371 of International Application No. PCT/EP2021/057958, filed on Mar. 26, 2021 and which claims benefit to European Patent Application No. 20167600.4, filed on Apr. 1, 2020. The International Application was published in German on Oct. 7, 2021 as WO 2021/198079 A1 under PCT Article 21(2).

### FIELD

The present invention relates to a photocatalytically active particulate material based on ZnS which is stable as regards photocorrosive self-degradation, to a method for the preparation thereof, and to the use thereof.

### BACKGROUND

The photocorrosion of pure ZnS significantly impairs its use in many fields such as, for example, in the use of pigments, in photocatalysis or as UV sensors, in LEDs as well as in luminophors. Photocorrosion is a highly thermodynamically favored degradation process which is caused by the simultaneous presence of water (for example, in the form of moisture in the air) and UV light. Corrosion products such Zn⁰, S⁰, ZnSO₄, ZnO, Zn(OH)₂ and H₂ are formed in the case of ZnS.

Because of its low Moh's hardness, ZnS constitutes, for example, an important white pigment as an additive to polymers, which is why the elemental zinc formed during corrosion and associated greying constitute major problems. ZnS is also considered to be a promising material for photocatalytic processes; because it exhibits high efficiency in charge carrier formation, the photogenerated charge carriers have a long lifetime and because of the position of the band edge potentials, it has high reducing and oxidizing powers. In competition with the desired photocatalytic processes such as, for example, water reduction or the degradation of contaminants in wastewater, however, is the thermodynamically more favorable photocorrosion, which considerably impairs its use as a photocatalyst because under the reaction conditions, ZnS will always self-degrade.

In order to obtain UV-stable ZnS pigments, it has been the conventional practice for almost 100 years in the pigment industry art to incorporate transition metals such as Co, Ni or Fe into the ZnS lattice in small quantities. It is assumed that these transition metals function as a kind of “buffer” for the photogenerated charge carriers, whereupon the number of these charge carriers is significantly or completely reduced and as a consequence, the photoluminescence of the zinc sulfide is considerably weakened. Photocorrosion can thereby also be suppressed because fewer or even no charge carriers reach the surface of the ZnS particles where photocorrosion would occur. For photochemical applications, however, this approach is not expedient, because the photogenerated charge carriers on the particle surface are required for the desired target reaction.

Other publications describe doping or coating ZnS particles. Yuan in Nanotechnology 2007, 95607, describes particles with a core of ZnS doped with Ag and Cl, wherein chlorine and silver ions are securely incorporated into the entirety of the ZnS lattice and the particles are covered with a layer of SiO₂.

WO 2013/185753 describes the wet chemical coating of ZnS particles, the surface of which have already been treated with Co²⁺ ions. It therefore pertains to impregnation, during which Co²⁺ is applied to the ZnS surface. These Co²⁺ ions are then fixed by an inorganic layer and securely incorporated into it.

US 20141/174906 describes colloidal nanocrystals which can be used as photocatalysts. The surface of the nanocrystals is therefore coated with oxidation or reduction catalysts. However, these “inorganic capping agents” only cover part of the surface of the carrier particles and do not function as a protective layer.

In order to be able to use ZnS as a photocatalyst in scientific research, what are known as sacrificial reagents (for example, Na₂S and Na₂SO₃) are used which have thermodynamically more favorable oxidation potentials compared with ZnS. Photogenerated holes thus oxidize Na₂S and Na₂SO₃ to form sulphates and the photogenerated electrons bring about, for example, the reduction of water (H₂ formation). However, because of the consumption of Na₂S and Na₂SO₃, this approach to H₂ formation is not appropriate for industrial application because enormous quantities of these sacrificial reagents would have to be used.

A further possibility for suppressing photocorrosion is to coat the ZnS particles with inorganic materials in order to prevent contact between water and the ZnS surface. A large number of patent applications are thus known in the prior art which concern the coating of ZnS particles in order to increase weather resistance and photostability or to avoid binder degradation. Examples are U.S. Pat. No. 2,885,366, DE 1151892, DE 102013105794 A1, DE 1178963 B as well as CN 102942922 A.

In the case of the inorganic coating of ZnS particles by a wet chemical synthesis pathway, however, the lack of homogeneity of the layers prepared has occasionally proved to be problematic. Layers of this type must be as dense as possible in order to provide complete weather resistance and photostability; in the studies mentioned above, in most cases, only an increased rather than complete stability was obtained.

It is also known that gas phase processes (for example, Atomic Layer Deposition—ALD) can be employed to obtain a more controlled layer growth. ALD processes of this type are described in the manual “Atomic Layer Deposition: Principles, Characteristics, and Nanotechnology Applications”; Wiley; 2013.

Cheng and Mao have described that an approximately 10 nm thick Al₂O₃ layer can sufficiently protect sulfide particles (ZnS core/shell system) against photocorrosion in an O₂ atmosphere. The use of the particles is, however, limited to the LED field, wherein a recombination of the charge carriers occurs inside the particles, leading to the emission of light. The charge carriers here must therefore not get through the protective layer.

In the case of photocatalytic processes, it is vital, however, for the charge carriers to undergo redox reactions with adsorbed molecules, and therefore photogenerated charge carriers must be able to get through the isolating layer. The protective layers for ZnS in the photocatalysis field must therefore be significantly thinner so that charge transfer is possible via a tunnelling process. Appropriately thin layers with a layer thickness of up to 2 nm were used in the aforementioned studies, but the problem here arose that such thing layers exhibit an increased, but not a complete photostability, so that a long-term use of photocatalysts of this type is not possible.

The use of particles of ZnS and metal is thus well known to the person skilled in the art, but the simultaneous suppression of photocorrosion while obtaining the photocatalytic properties constitutes a considerable challenge which has not yet been solved in the art.

### SUMMARY

In an embodiment, the present invention provides a photocatalytically active particulate material which includes a particle core of ZnS, particles of a nanoscale metal selected from Au, Ag, Pt, Pd, Cu or an alloy thereof loaded on the particle core, and a layer of Al₂O₃, SiO₂, TiO₂ or mixtures thereof on the loaded particle core.

### BRIEF DESCRIPTION OF THE DRAWINGS

The present invention is described in greater detail below on the basis of embodiments and of the drawings in which:

FIG. 1 shows the normalized photoluminescence intensity (PL intensity) after 40 minutes of UV irradiation as a function of the deposited Al content and the calculated layer thickness (the normalization was carried out in each case with respect to the integral of the PL emission band at the time point to). In the three traces, the irradiated surface area is shown after the UV exposure: beyond 90%, no greying can be seen;

FIG. 2 shows a plot against time of normalized PL intensity during 40 minutes of UV irradiation as a function of deposited Al content. Every 90 seconds, an emission spectrum was recorded which was integrated and then normalized to the integral at time point t₀;

FIG. 3 shows PL spectra before and after UV irradiation of pure cobalt-free ZnS (A of FIG. 3) and of sachtolith L (B of FIG. 3) as well as images of the irradiated surfaces;

FIG. 4 shows the effect of calcining in N₂ or ambient air (O₂) on the photostability of pure cobalt-free ZnS and ZnS@Al₂O₃;

FIG. 5 shows the loss of ZnS by reaction with Ag⁺ ions for coated ZnS samples with different proportions of Al (% by weight);

FIG. 6 shows a photographic image of a ZnS—Au educt material and the coated samples;

FIG. 7 shows SEM images of selected samples of FIG. 6;

FIG. 8 shows a solid UV/vis spectra of different coated ZnS or ZnS—Au samples of FIG. 6;

FIG. 9: shows a normalized, relative PL intensity after 40 minutes of UV irradiation of ZnS, ZnS—Au and ZnS—Au@Al₂O₃ particles; and

FIG. 10 shows the photo-induced degradation of methyl orange under UV irradiation (100 W Hg—Xe lamp). The error bars shown the result from two irradiation experiments in each case.

### DETAILED DESCRIPTION

Starting from this prior art, the present invention has pursued the approach of modifying spherical, cobalt-free zinc sulfide particles (number average d₅₀ on the 400 nm scale) on the particle surface initially with laser-generated spherical gold nanoparticles (Au—NP approximately 5-8 nm) and therefore with approximately 0.5% to 1.5% by weight, in particular 0.8% to 1.2% by weight, more particularly with approximately 1% by weight of Au with respect to the total weight of the photocatalytically active particulate material, and finally, coating the ZnS—Au particles with Al₂O₃ (˜2-5 nm thick) by means of an ALD process. This constitutes a first embodiment of the present invention.

The particular feature of the present invention is that initially, a photostable ZnS material is obtained which at the same time still exhibits activity in respect of photocatalysis.

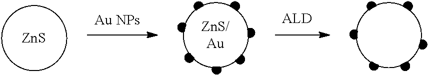

In general, the present invention concerns a photocatalytically active particulate material:
with a particle core of ZnS,
with a loading of particles of nanoscale metal selected from Au, Ag, Pt, Pd, Cu or an alloy thereof on the particle core, and
with a layer of Al₂O₃, SiO₂, TiO₂ or mixtures thereof around the loaded particle core.

The term “nanoparticle” or “nanoscale particle” in the context of the present invention should be understood to mean particles which have a diameter of less than 20 nm.

In this regard, the particulate material in accordance with the present invention has a particle size in the particle core (as a number average) d50 in the range from 300 to 500 nm, in particular 300 to 450 nm, more particularly 380 to 450 nm.

As a rule, the photocatalytically active particulate material has a loading of 0.5% to 1.5% by weight, in particular 0.8% to 1.2% by weight, with respect to the total weight of the photocatalytically active particulate material of nanoscale metal selected from Au, Ag, Pt, Pd, Cu or an alloy thereof.

In this regard, the number average particle size (d₅₀) of the nanoscale metal selected from Au, Ag, Pt, Pd, Cu or an alloy thereof can, for example, be 4 to 10 nm, in particular 5 to 8 nm.

In accordance with the present invention, the layer of Al₂O₃, SiO₂, TiO₂ or mixtures thereof around the loaded particle core is present in a quantity of at least 1.2% by weight, in particular at least 1.4% by weight, calculated as the metal and with respect to the total weight of the photocatalytically active particulate material. Depending on the particle size, a layer thickness of at least 2 nm is thus produced, in particular at least 3 nm and, more particularly, at least 4 nm. In this regard, the layer thickness can, for example, be selected in a manner so that the particles of nanoscale metal selected from Au, Ag, Pt, Pd, Cu or an alloy thereof on the particle core “protrude” out of the layer of Al₂O₃, SiO₂, TiO₂ or mixtures thereof and conducts charge from the particle core to the surface of the coated particle. The thickness of the layer of Al₂O₃, SiO₂, TiO₂ or mixtures thereof on the loaded particle core and around the particles of nanoscale metal is as a rule selected so as to be smaller than the particle size and therefore is also smaller than the largest particle size. As an example, the thickness of the layer of Al₂O₃, SiO₂, TiO₂ or mixtures thereof is approximately 2 to 5 nm and the particle size (d₅₀) of the nanoscale metal is in the range of 4 to 10 nm, in particular the 5 to 8 nm given above.

The present invention is also directed towards a method for preparing the photocatalytically active particulate material, in which the particles of ZnS are treated with particles of nanoscale metal selected from Au, Ag, Pt, Pd, Cu or an alloy thereof in an aqueous phase and the particles obtained are coated with Al₂O₃, SiO₂, TiO₂ or mixtures thereof.

In the method in accordance with the present invention, particles of nanoscale metal selected from Au, Ag, Pt, Pd and Cu or an alloy thereof can, for example, be used which are respectively prepared via pulsed laser ablation in liquid as or by via a wet chemical method. In accordance with the present invention, pulsed laser ablation in liquid is carried out, for example, in accordance with the publication in Chem. Rev. 2017, 117, 3990-4103 or Photonik 43 (2011), No. 1, pp. 50-53 in a manner such that a high-energy pulsed laser beam is focused on a sheet of Au, Ag, Pt, Pd or Cu or an alloy thereof which is in an aqueous solution. The surface of the sheet metal is removed via the laser beam, whereupon the nanoparticles are formed which are obtained in the aqueous phase.

When using a wet chemical method in accordance with the present invention, the metal nanoparticles can, for example, be prepared via a reduction of the corresponding metal salt in an aqueous or organic phase with the aid of a reducing agent such as, for example, sodium citrate, hydrogen or sodium borohydride. As an example, this method has been described in the publications J. Am. Chem. Soc. 2006, 128, 3, 917-924 or Phys. Chem. Chem. Phys., 2011, 13, 2457-2487.

The layer of Al₂O₃, SiO₂, TiO₂ or mixtures thereof around the loaded particle core can, for example, be prepared by coating using atomic layer deposition in a cyclic process, wherein, for example, at least five cycles, in particular at least 12 cycles are carried out.

Finally, the photocatalytically active particulate material obtained may undergo calcining in a temperature range of 400° C. to 600° C. over a time period of at least two hours.

The photocatalytically active particulate material is particularly suitable for use as a pigment or as a photocatalyst.

In accordance with the present invention, the ZnS particles may be prepared using a standard method via precipitation from Na₂SO₄+ZnSO₄ with a subsequent calcining.

In accordance with the present invention, the Au NPs may be obtained by a pulsed laser ablation in liquid (PLAL). In contrast to wet chemically synthesized NPs, particles prepared by PLAL have a “purer” surface because the use of precursors and ligands can be dispensed with. The Au NP particles may be generated in accordance with the publication in Chem. Rev. 2017, 117, 3990-4103 or Photonik 43 (2011), No. 1, pp 50-53.

In accordance with the present invention, the Atomic Layer Deposition (ALD) may be carried out with the precursors trimethylaluminum (TMA) and H₂O at a temperature of 150° C. The number of cycles was varied between 5 and 50, whereupon between 0.6% and 5.8% by weight of Al was deposited. If desired, the Al₂O₃@ZnS—Au particles can subsequently be calcined further (T˜500° C.), further improving the photostability.

The present invention will now be explained in greater detail with the aid of the accompanying drawings.

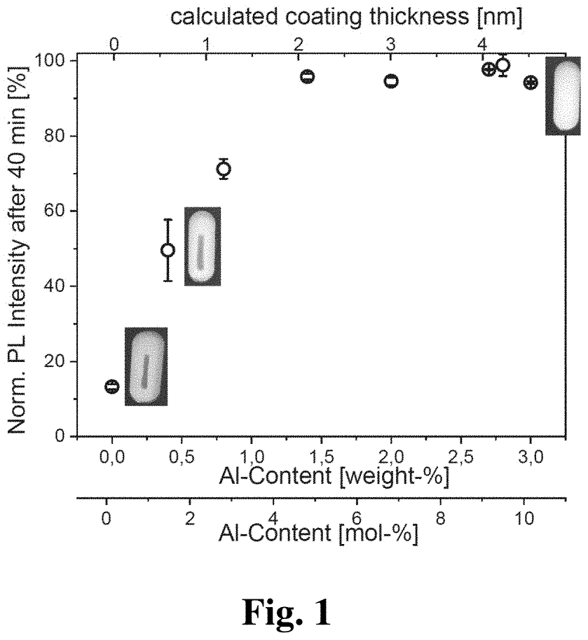

As can be seen in FIGS. 1 to 4 for the coating of ZnS with Al₂O₃, this coating results in an increase in the photostability of the particles.

In the drawings, the results for coated zinc sulfides without Au NPs are shown (ZnS@Al₂O₃ particles). In order to assess the photostability, the photocorrosive Zn⁰ formation was investigated using photoluminescence spectroscopy (PL). To this end, the reduction in the photoluminescence intensity of the respective samples (in the form of ZnS pastes) during intensive UV irradiation was monitored (see FIG. 1). Untreated ZnS greyed extremely severely, and hence the PL intensity after the UV irradiation was only approximately 15%. After coating with Al₂O₃, an increase in the photostability could be obtained with increasing Al content. Proportions of Al above 1.4% by weight, which corresponded to a calculated layer thickness of 2 nm, obtain a near-complete maintenance of the PL intensity following the UV irradiation (intensities between 90-100%), when no further greying of the surface could be observed.

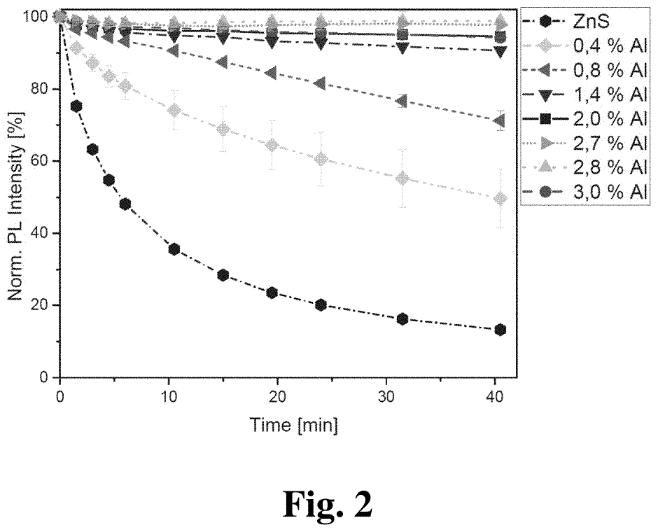

A comparison of the photostability over PL intensities with cobalt-stabilized ZnS (sachtolith L) as the reference material is rather problematic because cobalt acts as a buffer for photogenerated charge carriers and therefore functions as what is known as a “killer” with respect to photoluminescence (see FIG. 3; for comparison purposes, on the left A, a pure cobalt-free ZnS is shown). With the aid of the images before and after coating, however, it can be seen that even the reference material sachtolith L greys very slightly under the action of the intensive UV. Via the Al₂O₃ coating alone, a higher photostability compared with cobalt doping could thus be obtained because in this, above 1.4% by weight Al, which corresponds to a calculated layer thickness of 2 nm, no further greying of the irradiated surface could be observed (compare FIGS. 1 and 2).

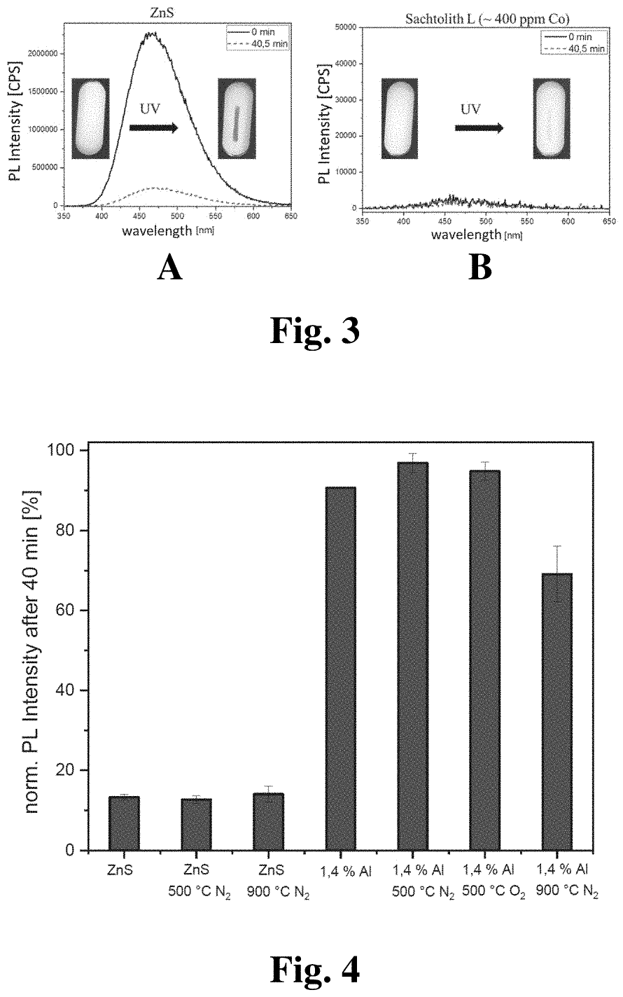

A further positive effect is exhibited by calcining the coated samples at 500° C. in ambient air or a nitrogen atmosphere. As can be seen in FIG. 4, the photostability increases slightly with calcining at 500° C. Calcining at 900° C., on the other hand, leads to a reduction in the photostability.

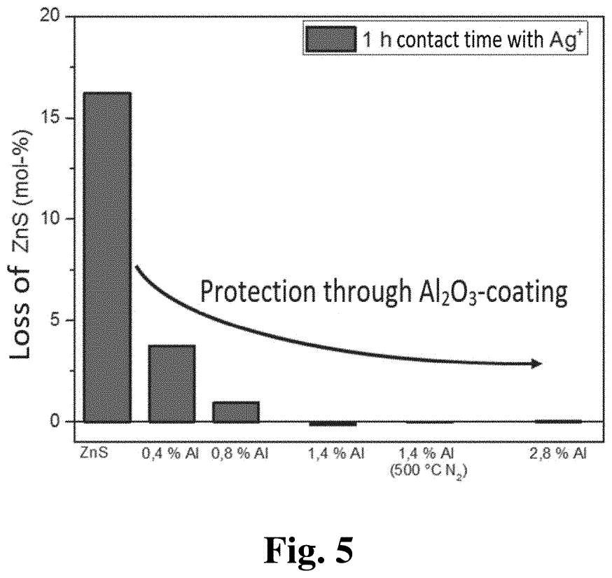

In order to evaluate whether the coated samples still have a sulfided surface or a dense Al₂O₃ layer is present, the reaction on the surface with Ag⁺ ions was investigated. The sulfided surface of ZnS reacts with Ag⁺ ions to form Ag₂S, whereupon the surface turns brownish and the corresponding consumption of silver ions can be used to quantify the loss of ZnS (see FIG. 5). FIG. 5 shows that above 1.4% by weight Al, there is no longer a sulfide surface (no consumption of Ag⁺ ions) and thus the ZnS main body in the context of the coating has been completely covered with aluminum oxide.

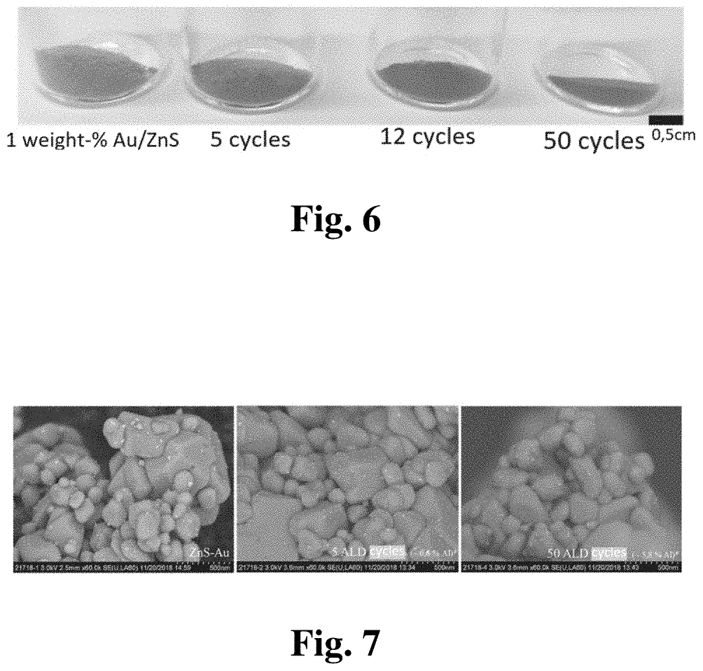

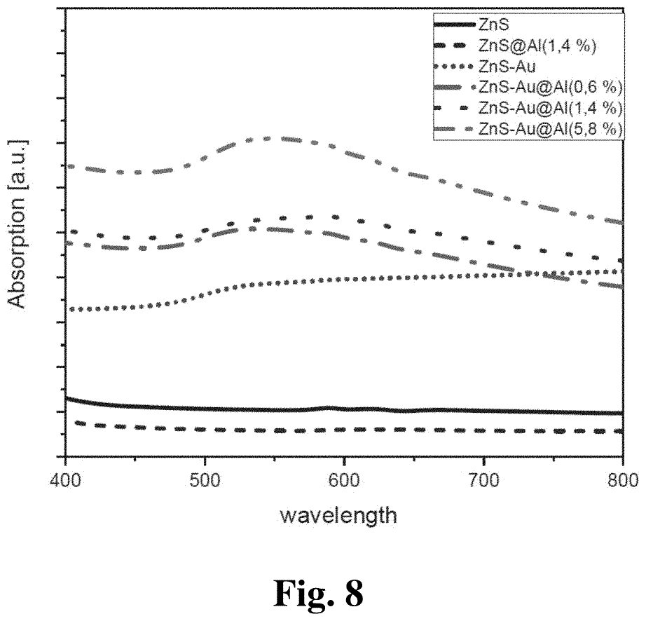

FIGS. 6 to 10 show the results of coating ZnS—Au particles with Al₂O₃(ZnS—Au@ Al₂O₃ particles). In this regard, the particles are ZnS particles to the surfaces of which Au NPs have been applied (1% by weight) before coating by means of ALD (FIG. 6; 5, 12 & 50 cycles; this corresponds to calculated Al contents of 0.6%, 1.4% and 5.8% by weight). FIG. 7 shows selected SEM images; a homogeneous distribution of the AU NPs can be seen therein. FIG. 8 furthermore shows that surface plasmon resonance of the AU NPs has been obtained (at approximately 530 nm), which can be seen in the corresponding main body UV/vis spectra.

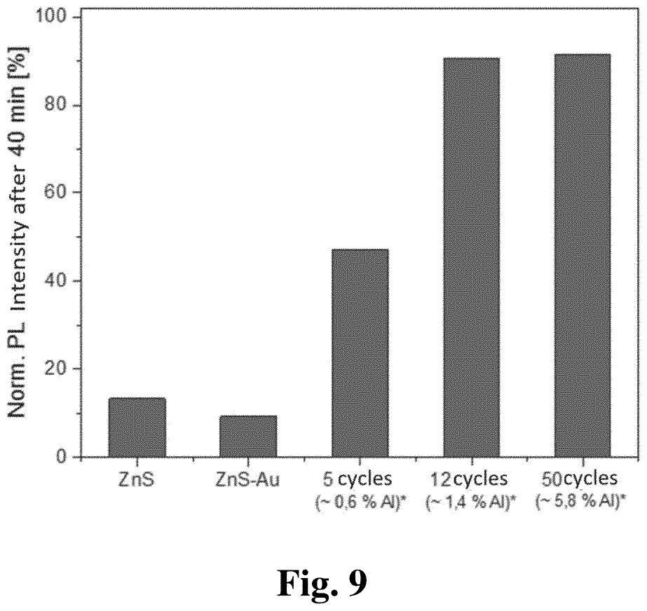

FIG. 9 shows the photostability of the ZnS and ZnS—Au educts, as well as ZnS—Au particles which were coated by atomic layer deposition for 5, 12 and 50 cycles. It can here be seen that uncoated ZnS—Au is somewhat more sensitive to light than pure ZnS. Beyond 12 ALD cycles (approximately 1.4% by weight Al), however, a sufficient photostability could be obtained.

The evaluation of the photoactivity of photostable samples was carried out by means of the photo-induced bleaching of methyl orange, wherein photogenerated charge carriers cause the degradation of the dye. In order to investigate the effect of the Au NPs, coated ZnS samples with the same Al content (approximately 1.4% by weight) with and without Au were investigated. A comparison of FIGS. 1 and 9 also shows that both samples have an identical photostability (PL intensity after UV irradiation approximately 90%).

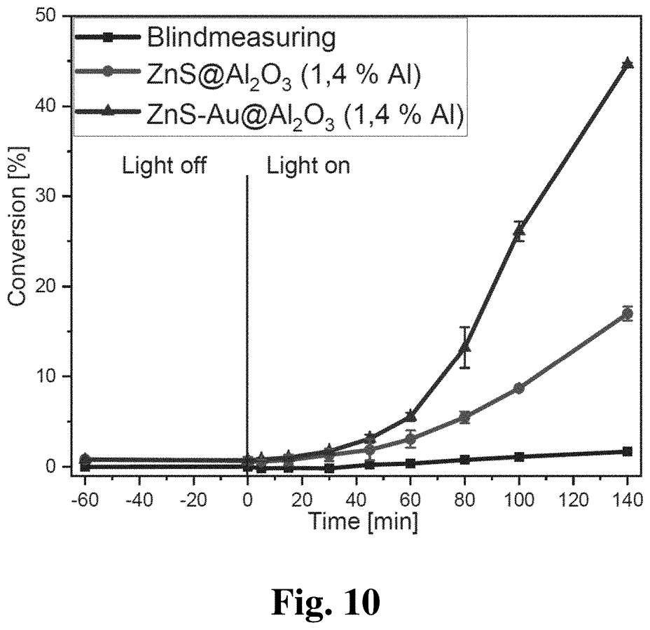

FIG. 10 shows the degradation of methyl orange (conversion [%]) against the irradiation time (0-140 min). In the time period −60 to 0 min, no irradiation was carried out, in order to exclude any possible adsorption effects. It can be seen that ZnS with a layer of Al₂O₃ but without Au nanoparticles has a low activity as regards photo-induced dye degradation, wherein 16% of the dye had been bleached after 140 min. On the other hand, when Au NPs have been deposited on the ZnS surface prior to Al₂O₃ coating, almost three times as much dye degradation is obtained (45% after 140 min). The blank measurement (irradiation without catalyst) exhibited bleaching of only 1.7% after 140 min and can therefore be ignored.

The data thus shows that a photostable ZnS main body can be prepared via an Al₂O₃ coating, but it only exhibits a low photo-induced activity in respect of dye degradation.

Compared thereto, the combination of Au NPs and Al₂O₃ coating in accordance with the present invention results in a significant increase in activity, which is indicative of the interaction in respect of the charge carriers between ZnS main bodies and Au NPs.

In addition to the use of laser-generated Au nanoparticles of the example, the system in accordance with the present invention can also be described with other conductive nanoparticles such as Ag, Pt, Pd, Cu and their alloys which can be prepared in an analogous manner by pulsed laser ablation (refer to Chem. Rev. 2017, 117, 3990-4103).

The use of an inert inorganic shell in accordance with the present invention in order to protect the particle surface, shown by way of example for Al₂O₃, can also be applied to the materials SiO₂ and TiO₂ which also constitute conventional materials in the context of atomic layer deposition (Crit Rev Solid State, 38:203-233, 2013).

### Methods and Apparatus

### Methods

### Photocorrosion Determination

In order to investigate the photostability via photoluminescence spectroscopy, firstly, 300-400 mg of sample was ground and mixed with 150-200 mg of demineralized water. The paste obtained was placed on a plastic support, covered with a quartz glass slide, and inserted into the Fluorolog®-3 fluorescence spectrometer from HORIBA. Next, the sample was irradiated for 40.5 min at an excitation wavelength of 330±2 nm, wherein every 90 seconds, an emission spectrum was recorded from 350 to 650 nm (slit width to detector 1 nm). By integrating the respective emission bands and subsequent normalization to the integral at time point to, the relative reduction in the photoluminescence intensity with time could be determined; this constitutes a measure of the susceptibility to photocorrosive greying.

### Determination of Al Content

In order to quantify the deposited quantity of Al, 300 mg of the respective sample was placed in a 250 mL dual-necked flask and 100 mL of 2N HCl was added. Next, the dispersion was heated to 90° C. and stirred for 3 h. During this time, the reaction solution was continuously flushed with N₂ (2 L/h) in order to drive off the H₂S which formed. The clear solution was then investigated by ICP-mass spectrometry in respect of the Al³⁺ concentration.

### Investigation of Layer Density Using AgNO₃

50 mg of the powdered sample was placed in 44 mL of demineralized water and dispersed for 2 minutes in an ultrasound bath. Next, 6 mL of 0.1M silver nitrate solution was added to the dispersion, with stirring. After one hour, the dispersion was centrifuged for 20 min at 5000 rpm and the clear supernatant was removed. Next, the Ag⁺ concentration of the supernatant was determined by a Volhard titration in order to quantify the quantity of silver ions which had not reacted with the ZnS surface. To this end, 10 mL of the supernatant was made up to 100 mL with distilled water. Next, as an indicator, a few drops of ammonium iron(III) sulphate solution (0.1M) were added which had been supplemented with concentrated nitric acid until the brown color of the solution disappeared. A 0.01M ammonium thiocyanate solution was used as the standard solution.

The relative loss of ZnS could then be calculated via the Ag⁺ concentration in the supernatant:

$$loss of ZnS [ mol - \% ] = \frac{{n}_{0} ( {Ag}^{+} ) - {n}_{t} ( {Ag}^{+} )}{2 \cdot n ( ZnS )} \cdot 100 \%$$

n₀ (Ag⁺)=initial molarity of Ag⁺ ions [mol]
nₜ (Ag⁺)=consumed molarity of Ag⁺ ions during the titration [mol]
n (ZnS)=molarity of ZnS [mol]

### SEM Investigation

The SEM measurements were carried out with the aid of the SU-70 scanning electron microscope from Hitachi. In the context of preparation, the powdered samples were initially placed in ethanol and dispersed in an ultrasound bath for 1 min. A few drops of the suspension were placed on a graphite wafer, which was then dried at 50° C. in a vacuum drying oven.

### UV/Vis Spectroscopy

The solid body samples were measured using the Cary 400 spectrometer from Varian. The wavelength range was 400-800 nm with a resolution of 1 nm; spectralon was used as the white standard.

### Particle Size Determination

The particle size determination was carried out with the aid of an analytical disk centrifuge from CPS Instruments (model DC 24000). The calibration was carried out using PCV particles (d=0.237 μm; standard), wherein the detection wavelength was 450 nm. The number average particle diameter (d₅₀) was determined via the cumulative size distribution by mass.

### Layer Thickness Determination

The thickness (d) of the applied layers can be calculated with the aid of the following formula based on the BET surface area of the ZnS main body, the density of the Al, Ti or Si species, and the deposited molarity of Al, Si or Ti:

$${V}_{S} = {O}_{BET} \cdot d$$

$${V}_{S} = \frac{{n}_{A 1}}{{ρ}_{molar}}$$

$$d = \frac{{n}_{A 1}}{{ρ}_{molar} \cdot {O}_{BET}}$$

V_{S}: volume of deposited layer [m³]
O_{BET}: BET-surface area of ZnS main body (4.8 m²/g)
d: thickness of layer [m]
n_{Al}: molarity of Al (Si, Ti) [mol]
ρₘₒₗₐᵣ: molar density of deposited layer (ρ_{Al}: 5.134×10⁴ mol/m³; ρ_{Ti} 5.297×10⁴ mol/m³; ρ_{Si}: 4.411×10⁴ mol/m³)

### Dye Degradation

In order to investigate the photo-induced dye degradation, initially, 21 mg of the powdered sample was dispersed in 84 mL of methyl orange solution (18 mg/L) for 1 min in an ultrasound bath and placed in a quartz glass reactor. Subsequently, the dispersion was stored for 60 min in the dark so that an adsorption-desorption equilibrium could be established. Next, irradiation was carried out via a 200 W He(Hg) arc lamp with an upstream neutral density filter (50%). In this regard, the reaction volume was stirred continuously and flushed with synthetic air (5 mL/min). At time points 0, 5, 15, 30, 45, 60, 80, 100 and 140 min, a volume of approximately 1.5 mL was removed and centrifuged for 10 min at 15000 rpm in order to obtain sedimentation of the catalyst material. Next, the supernatant was investigated in respect of the concentration of methyl orange using the Evolution 201 UV/vis spectrometer from Thermo Scientific and the degradation of the methyl orange was determined using the following formula:

$$X = \frac{{c}_{0} - {c}_{t}}{{c}_{0}} = \frac{{E}_{0} - {E}_{t}}{{E}_{0}}$$

E₀ or Eₜ: extinction at time point 0 or t [WLOG]
X: conversion [WLOG]
c₀ or cₜ: concentration at time point 0 or t [mol/L]

### PREPARATION EXAMPLES

### Chemicals Used

Trimethylaluminum solution (97%; Sigma Aldrich)

Sheet gold (99.99%; 1 mm thick; Allgemeine Gold- and Silberscheideanstalt AG)

Sodium hydroxide pellets (>98%, Sigma Aldrich)

Silver nitrate powder (>99%, Sigma Aldrich)

Ammonium iron(III)sulphate solution (0.1N; Bernd Kraft)

0.01M ammonium thiocyanate solution (0.1N Reag. Ph. Eur.; Bernd Kraft

Methyl orange powder (ACS Reagenz, dye content 85%; Sigma Aldrich

2N hydrochloric acid (Reag. Ph. Eu; Fluka Analytical)

Nitrogen (99.999%, Alphagaz Air Liquide)

Synthetic air (99.999%, Alphagaz Air Liquide)

### Syntheses

### Synthesis of ZnS Particles

The zinc sulfide was prepared by means of continuous precipitation with the aid of ZnSO₄ and Na₂S solutions which were commercially available. For the precipitation, the two solutions were initially heated to 65° C. before mixing of both educts was then carried out in the reactor vessel. Sufficient mixing during the reaction was obtained via an appropriate stirrer (400 rpm). After precipitation, more Na₂S solution was added, with stirring, to the reaction mixture obtained until the pH was 7-7.5. After this, the ZnS was separated from the solution with the aid of a Büchner funnel and the filter cake was dried for 8 h in a drying oven at 130° C. The ZnS obtained in this manner was then calcined in an electric tube furnace in ambient air. After calcining, the calcined sample was immediately quenched in approximately 1000 mL of water and dispersed (approximately 6400 rpm and 10 min), washed, and the solid was separated by a Büchner funnel. The filter cake obtained was then dried for approximately 1 h in the drying oven at 130° C. and then ground for 1 min using an IKA laboratory mill.

Synthesis of Au Nanoparticles and Deposition thereof on ZnS

Colloids which had been prepared by pulsed laser ablation in liquid (PLAL) were used to support the laser-generated Au nanoparticles. The synthesis of the Au nanoparticles was carried out with the aid of a nanosecond Nd:YAG-Laser IS400-1 from Edgewave. To this end, an Au target (sheet Au with a thickness of 1 mm) was fixed in a flow chamber, wherein 0.5 mM of NaOH solution was pumped at a flow rate of 100 mL/min through the ablation chamber. The Au target was irradiated with the laser light (wavelength 1064 nm) via a quartz glass window in the flow chamber in a moving rectangular pattern; this was carried out via a scanner system (Sunny S-8210D, scan speed 2 ms⁻¹) with a Linos F Theta lens (focal length 100 mm). For the pulsed laser beam, a repetition rate of 5 kHz and a pump current of 54 A were used. The Au colloid prepared in this manner was trapped in a downstream collecting container. In order to apply the Au nanoparticles to the zinc sulfide, 16 g of ZnS was added to 1 L of distilled water and dispersed for 1 min in the ultrasound bath, with stirring. Next, with stirring, 1.5 L of the previously prepared Au colloid (Au concentration 107.7 mg/L) was dripped into the ZnS suspension at a flow rate of 25 mL/min, corresponding to a mass loading of 1.0% by weight. The dispersions were then stirred for 60 min. Next, the particles were filtered off, washed twice with 500 mL of distilled water each time, and dried in the drying oven at 100° C. for 30 min.

In addition to using Au nanoparticles, laser ablation can also be used for other materials such as Ag, Pt, Pd, Cu and their alloys (Chem. Rev. 2017, 117, 3990-4103). For this, only the target of the desired material is used in the context of laser ablation. In this manner, the “Hedgehog particles” described here are not restricted to Au nanoparticles alone, but may also be prepared with nanoscale Ag, Pt, Pd, Cu and their alloys.

Coating with Al₂O₃

Atomic layer deposition (ALD) of Al₂O₃ was carried out using the commercially available Savannah® system from Veeco. Firstly, 2 g of ZnS or ZnS—Au powder was added to the rotating drum reactor, the system was evacuated and the reactor chamber was heated to 150° C. Next, the rotational speed of the rotating drum reactor was adjusted to 4 rotations per minute. In order to remove physisorbed water, a 45-minute drying step was carried out at an Ar flow rate of 20 sccm (carrier gas). Next, the two precursors, trimethylaluminum (TMA) and demineralized water, were added in alternation; they could be introduced into the ALD system in the gaseous form via cartridges (heated to a temperature of 25° C.). The table below describes the sequence for a single deposition cycle in detail:

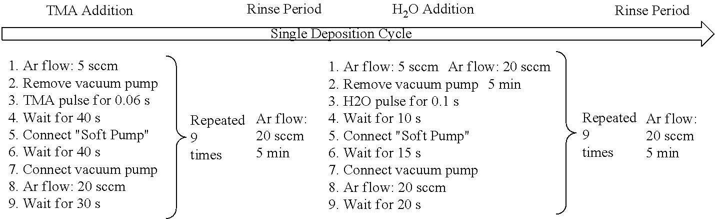

In the context of the experimental work, the number of deposition cycles was varied between 5 and 50 in order to vary the quantity of the aluminum species to be deposited. After coating was complete, the pressure in the reactor chamber was slowly increased with the aid of the Ar flow to ambient pressure and the sample material was removed.

In addition to coating with Al₂O₃, this method can also be used for preparing layers of SiO₂ or TiO₂. To this end, precursors such as, for example, titanium tetraethanolate, titanium tetramethanolate, 3-aminopropyltriethoxysilane or tetrachlorosilane may be used; The “Hedgehog particles” here described are thus not restricted to Al₂O₃ shells alone, but can also be coated with SiO₂ or TiO₂.

### Calcining of Coated Samples

Selected samples were calcined following ALD coating in synthetic air or under a nitrogen atmosphere. To this end, 800 mg of each sample was transferred into a quartz glass crucible and inserted into the work tube (quartz glass) of the compact tube furnace from Carbolite. This could be flushed with an appropriate gas via two gas connections (volume flow rate: 8 L/h). Before calcining was begun, a 12 hour flushing period was carried out with the respective gas. Next, the temperature was increased at a heating rate of 5° C./min to 500° C. or 900° C. and held for 2 h. After cooling the furnace to room temperature, the sample material was removed.

The present invention is not limited to embodiments described herein; reference should be had to the appended claims.

What is claimed is:

1-12. (canceled)

13: A photocatalytically active particulate material comprising:
a particle core of ZnS;
particles of a nanoscale metal selected from Au, Ag, Pt, Pd, Cu or an alloy thereof loaded on the particle core; and
a layer of Al₂O₃, SiO₂, TiO₂ or mixtures thereof on the loaded particle core.

14: The photocatalytically active particulate material as recited in claim 13, wherein a particle size d₅₀ of the particle core is in the range of from 300 to 500 nm.

15: The photocatalytically active particulate material as recited in claim 13, wherein 0.5% to 1.5% by weight of the particles of the nanoscale metal selected from Au, Ag, Pt, Pd, Cu or the alloy thereof are loaded on the particle core with respect to a total weight of the photocatalytically active particulate material.

16: The photocatalytically active particulate material as recited in claim 13, wherein a particle size of the particles of the nanoscale metal selected from Au, Ag, Pt, Pd, Cu or the alloy thereof is 4 to 10 nm.

17: The photocatalytically active particulate material as recited in claim 13, wherein the layer of Al₂O₃, SiO₂, TiO₂ or mixtures thereof on the loaded particle core is at least 1.2% by weight calculated as the metal and with respect to a total weight of the photocatalytically active particulate material.

18: The photocatalytically active particulate material as recited in claim 13, wherein a thickness of the layer of Al₂O₃, SiO₂, TiO₂ or mixtures thereof on the loaded particle core is at least 2 nm.

19: A method for preparing the photocatalytically active particulate material as recited in claim 13, the method comprising:
treating particle cores of ZnS with particles of a nanoscale metal selected from Au, Ag, Pt, Pd, Cu or an alloy thereof in an aqueous phase so as to obtain particles which are loaded on the particle cores; and
coating the particles which are loaded on the particle cores with Al₂O₃, SiO₂, TiO₂ or mixtures thereof so as to obtain the photocatalytically active particulate material.

20: The method as recited in claim 19, wherein the particles of the nanoscale metal selected from Au, Ag, Pt, Pd, Cu or the alloy thereof are prepared via a pulsed laser ablation in a liquid or via a wet chemical method.

21: The method as recited in claim 19, wherein the coating of the particles which are loaded on the particle cores with Al₂O₃, SiO₂, TiO₂ or mixtures thereof is performed via an atomic layer deposition in a cyclic method.

22: The method as recited in claim 20, wherein the cyclic method includes performing at least five cycles.

23: The method as recited in claim 19, further comprising:
calcining the photocatalytically active particulate material obtained at a temperature of from 400° C. to 600° C. for at least two hours.

24: A method of using the photocatalytically active particulate material as recited in claim 13 as a pigment in a plastic, the method comprising:
providing the plastic;
providing the photocatalytically active particulate material as recited in claim 13; and
incorporating the photocatalytically active particulate material into the plastic.

25: A method of using the photocatalytically active particulate material as recited in claim 13 as a photocatalyst, the method comprising:
providing the photocatalytically active particulate material as recited in claim 13; and
using the photocatalytically active particulate material as the photocatalyst.
